(19) United States
(12) Patent Application Publication
(10) Pub. No.: US 2024/0119742 A1
(43) Pub. Date: Apr. 11, 2024

(54) METHODS AND SYSTEM FOR EXTRACTING TEXT FROM A VIDEO

(71) Applicant: L&T TECHNOLOGY SERVICES LIMITED, Chennai (IN)

(72) Inventors: Meet Amrutlal PATEL, Gandevi (IN); Sudhir BHADAURIA, Ahmedabad (IN); Madhusudan SINGH, Bangalore (IN); Manusinh THAKOR, Patan (IN)

(21) Appl. No.: 18/011,525

(22) PCT Filed: Sep. 8, 2022
(86) PCT No.: PCT/IB2022/058462

§ 371 Date: Dec. 19, 2022

(30) Foreign Application Priority Data
Sep. 9, 2021 (IN) 202141041000

(51) Int. Cl. G06V 20/62; G06F 16/783; G06V 20/40; G06V 30/19

(52) U.S. Cl. CPC G06V 20/62; G06F 16/7844; G06V 20/46; G06V 20/48; G06V 30/19013

(57) ABSTRACT

A method and system for extraction of text from a video for performing selective searching of text in the video is disclosed. The disclosure provides a text extraction device which receives a plurality of frames of a video. The frames may include at least one set of interrelated frames comprising a common text. A reference frame is identified comprising a reference pattern of a text in the frames. The reference pattern is matched with a pattern associated with a text within each of the frames. In order to do so, one or more interrelated frames are identified from the frames based on a pattern match. A set of interrelated frames is obtained comprising a text having a pattern matching the reference pattern. A relevant frame from the set of interrelated frames is selected based on text quality criteria and the common text is extracted from the relevant frame.

### TECHNICAL FIELD

This disclosure relates generally to method for text detection in a video file, and more particularly to a method for performing selective text detection in a video file.

### BACKGROUND

Video content, such as television programs, movies, commercials, online videos, etc. sometimes include text in various forms such as static text or moving text. Such static and moving text may appear or disappear at various times in the video. The text in a video may be of various forms and may be informative and useful to the viewer and may enhance viewer's experience. The text in a video may include, for example, information about the people such as, actors, musicians, photographers, etc. associated with each scene of the video and as well as subtitles of the dialogues associated to each scene of the video. However, the viewer has limited options in terms of searching, extracting, and consuming the text. For example, the viewer typically has little choice other than to write the text down for later use, as selective searching of text in the video content is challenging.

Some video Optical Character Recognition (OCR) algorithms are available. However, these may not work reliably for extracting the textual content from the video as resolution of the video may be low, and text embedded in the video may be small, and the background of the text may not be supportive in accurate text extraction. For example, typically, size of a character in the video may be less than 10*10 pixels and with such low resolution, the regular video OCR algorithms may not work reliably.

There is therefore a need to provide an improved and efficient method for performing selective detection and searching of text in a video.

### SUMMARY OF THE INVENTION

In an embodiment, a method for extraction of text for performing selective searching of text in a video file is disclosed. A plurality of frames may be received by a text extracting device. The plurality of frames may include at least one set of interrelated frames which may comprise one or more common text. A reference frame may be identified which may include a common text and a reference pattern may be identified associated to within the frame. In an embodiment, a reference pattern associated with a common text within the frame may be identified for each reference frame. The reference pattern may be identified by matching with a pattern associated with a text within each of the plurality of frames. The reference pattern may be matched with a pattern associated with a common text by identifying one or more interrelated frames from the plurality of frames. In an embodiment, the one or more interrelated frames may be identified based on a pattern match and may comprise a text having a pattern matching the reference pattern. Accordingly, the set of interrelated frames may be obtained. A relevant frame from the set of interrelated frames may be selected based on a text quality criterion. A common text may be extracted from the relevant frame.

In another embodiment, a system for extracting a borderless structure from a document is disclosed. The system may include one or more processors communicably connected to a memory, wherein the memory stores a plurality of processor-executable instructions, which, upon execution, cause the processor to receive a plurality of frames. The plurality of frames may include at least one set of interrelated frames which may comprise one or more common text. A reference frame may be identified which may include a common text and a reference pattern may be identified associated to within the frame. In an embodiment, a reference pattern associated with a common text within the frame may be identified for each reference frame. The reference pattern may be identified by matching with a pattern associated with a text within each of the plurality of frames. The reference pattern may be matched with a pattern associated with a common text by identifying one or more interrelated frames from the plurality of frames. In an embodiment, the one or more interrelated frames may be identified based on a pattern match and may comprise a text having a pattern matching the reference pattern. Accordingly, the set of interrelated frames may be obtained. A relevant frame from the set of interrelated frames may be selected based on a text quality criterion. A common text may be extracted from the relevant frame.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a text extraction system 100 for performing text detection for selective searching of text in a video file is illustrated, in accordance with an embodiment of the present disclosure

FIG. 2 illustrates an exemplary embodiment depicting a set of frames having a static text and a moving text in a video file, in accordance with an embodiment of the present disclosure.

FIG. 3A illustrates an exemplary embodiment for detecting a sequence of consecutive frames (set of frames) present in the video, in accordance with an embodiment of the present disclosure.

FIG. 3B illustrates an exemplary embodiment for detecting a sequence of consecutive frames (set of frames) present in the video, in accordance with an embodiment of the present disclosure.

FIG. 4 illustrates an exemplary embodiment depicting bucket creation of multiple frames present in the video, in accordance with an embodiment of the present disclosure.

FIG. 5 illustrates shows a table of exemplary text information detected for selective selection in a video, in accordance with an embodiment of the present disclosure.

FIG. 6 illustrates a process flow for extraction of text for performing selective searching of text in a video file, in accordance with an embodiment of the present disclosure.

FIG. 7 illustrates a block diagram of an environment 700 for extraction of text for performing selective searching of text in a video file, in accordance with an embodiment of the disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The disclosure pertains to selective searching of text in a video file. The text searching from the video file may be independent of language scripts being used in the text. In addition, the text may be searched in the video file irrespective of appearance of text i.e., irrespective of the text being static or non-static in a sequence of video frames. The disclosure may enable approximating most probable candidate of text to be extracted from the video file.

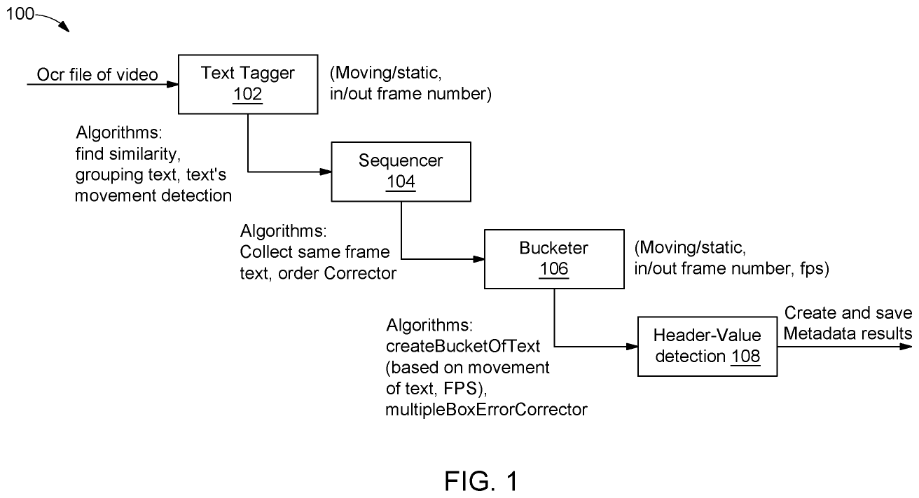

Referring now to FIG. 1, a block diagram of a text extraction system 100 for performing text detection for selective searching of text in a video file is illustrated, in accordance with an embodiment of the present disclosure. With respect to FIG. 1, the text extraction system 100 may receive as input an input file. The input file may be a video with multiple textual information. In an embodiment, the textual information may be in any language such as, but not limited to, English, Hindi, Malayalam, Telegu, etc. Further, the textual information present in the video may be recognized by using one or more text detection algorithms known in the art. The inputted video may comprise of various frames which may include various textual information in different frames of the video. At text tagger block 102, the video may be inputted and the textual information for each frame may be detected. A text file including all the textual information detected per frame may be generated. The text file may be of type, but not limited to, an Optical Character Recognition (OCR) file, a csv file, a json file, an xml file, or any other suitable type of file. Further, the received text file may include, for example, an extracted text data, a frame number on which the text data is detected, co-ordinates of the position of text data present in the frame. In an embodiment, each text data similar to each other may be assigned a unique box-id in order to identify similar text. In an embodiment, similar text may be present in continuously occurring frames or may be detected in different frames.

In an embodiment, the text tagger block 102 may locate a set of similar words or texts within the received input file and may group the set of similar words or texts. The text tagger block 102 may use one or more algorithms such as, but not limited to, Naive Bayes (NB) family of algorithms, Support Vector Machines (SVM), and deep learning algorithms, for finding similarity within the set of similar words or texts, algorithms for grouping text. Further, the text tagger block 102 may detect the position of the similar text in the consecutive frames in order to detect a movement of the similar text in consecutive frames. Further, an estimation of movement of one or more words in the video frames may be determined along with determination of co-ordinates of the words in each of the video frames. In addition, a box-id in form of a bounding box may be detected for each of the one or more words grouped in the list.

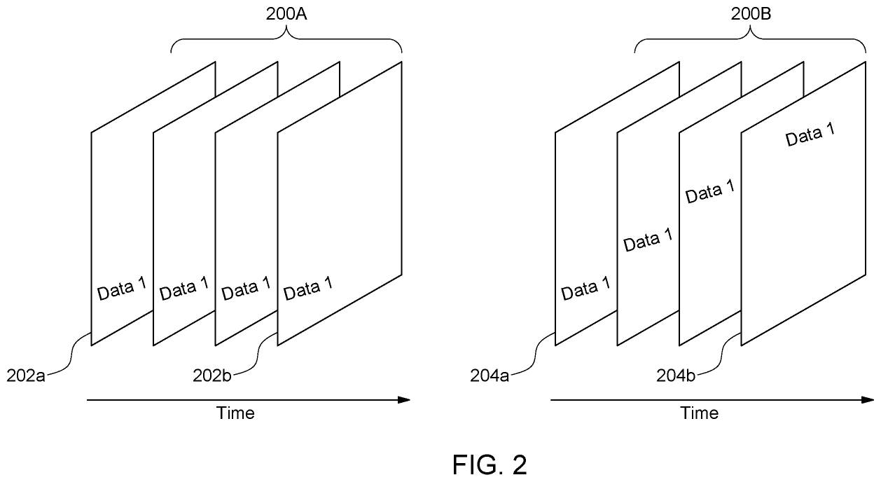

FIG. 2 illustrates an exemplary embodiment depicting a set of frames having a static text and a moving text in a video file, in accordance with an embodiment of the present disclosure. As mentioned above, and as shown in FIG. 2, the text “Data1” in the video frames may be at a static position in frames 200A. Thus, frames 200A may be interrelated frames which comprises similar text “Data1”. The text “Data1” is non-static in the sequence of video frames 200B. Accordingly, when the received input file includes a dynamic or non-static text, the movement of the text or words may be tracked based on its position from one frame to another for example, as shown in frames 200B, the text “Data1” may be seen moving from a bottom left most position in frame 204a to a top right most position in frame 204b. The tracking of the movement of the text or the one or more words may be based on determination of co-ordinates of the text or the words along with a detected box-id corresponding to the similar text. The frames 200B are thus, interrelated with respect to the present of similar text “Data1”. In an embodiment, each of the one or more words present in the dynamic text of the video may be tagged based on their position co-ordinates of the detected box-id. Accordingly, the movement of each of the one or more words present in the dynamic text in the video may be tagged. Also, each of the one or more words may be assigned an in-and-out frame number based on frame in which the one or more words first appear and disappear. Frame 202a is the in-frame in the group of interrelated frames 200A as the text “Data1” first appears in frame 202a. Frame 202b is the out-frame as the text “Data1” is last detected in frame 202b in the group of interrelated frames 200A.

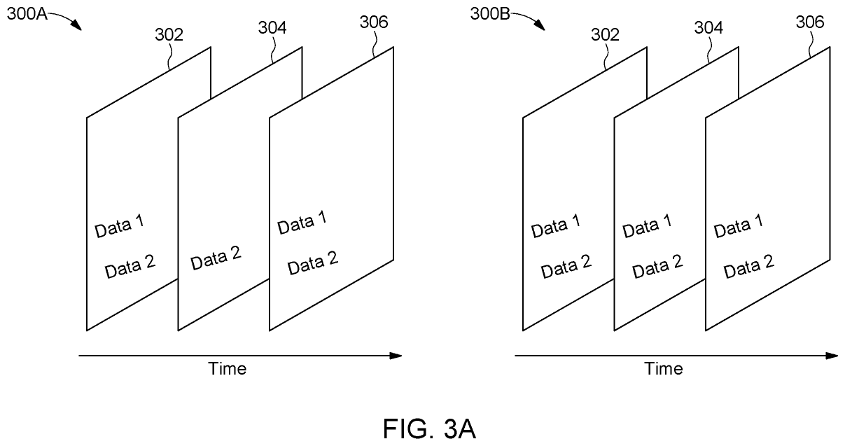

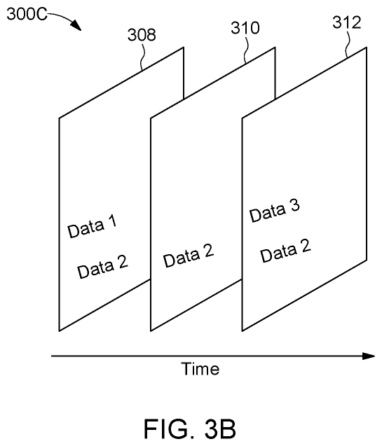

The text tagger block 102 may receive a set of multiple video frames associated with the video file comprising various texts. The received frames may include either static text or moving text. As is shown in FIG. 2, the static frames 200A may have data presented at a same position in a data frame over a time period. Further, the frames 200B may have data presented over different positions within the video frame over a specific time period. Multiple text characters in each of the video frames may be determined, where the text characters may be arranged in a particular sequence. The sequence of the text characters may remain same with respect to plurality of consecutive frames or may vary. On determining the multiple text characters, a set of related text characters maybe grouped to define a group of text characters which are detected across multiple video frames such as “Data1” in frames 200A and 200B. In an embodiment, along with “Data1” multiple related texts may be detected as described in detail in FIG. 3A and FIG. 3B. The grouping information may include obtaining coordinates associated with the plurality of text characters or bounding boxes associated with the plurality of text characters and utilized as text tags for each text character detected in the video frames.

The text tagged frames of the video determined at the text tagger block 102 may be sent as input to a sequencer block 104. The sequencer block 104 may be explained with respect to FIG. 3A. The FIG. 3A illustrates three consecutive frames 302, 304 and 306 present in the video file to be sequenced, in accordance with an embodiment of the present disclosure. The sequencer block 104 may use one or more algorithms for collecting the set of similar words or texts and correcting and predicting the presence of the detected set of similar words or text in consecutive frames. In an embodiment, the text tagger block 102 may detect a sequence of frames 300A in which the texts “Data1” and “Data2” may be detected in a frame 302 and only text “Data2” may be detected in the subsequent frame 304. Further, in the subsequent frame 306 again the text “Data1” and “Data2” may be detected. Therefore, the sequencer block 104 may determine a discrepancy in text detection by the text tagger block 102 in detection of the text “Data2” in frame 304. The sequencer block 104 may then correct the discrepancy in detection in the sequence of text frames 300B by including text “Data2” in frame 304 and may club the set of text characters present in the set of frames 300B. Further, the clubbing may be done in order to correct the detection of text due to various reasons such as dynamic background of the video frame 304 by the text tagger block 102.

FIG. 3B illustrates an exemplary embodiment for detecting a sequence of consecutive frames (set of frames) present in the video, in accordance with an embodiment of the present disclosure. In an embodiment, the sequencer block 104 may detect a sequence of frames 300C as shown in FIG. 3B in which the in-frame 308 may be detected to have texts “Data1” and “Data2” by the text tagger block 102. The subsequent frame 310 may be detected to have text “Data2” only and the next frame 312 may be detected to have texts “Data2” and “Data3”. The sequencer block 104 may determine a sequence of the frame 300C with respect to having a similar text “Data2” only. In an embodiment, the text sequencer block 102 and may determine the text “Data2” to be probable header information. The text “Data1” and “Data3” may be detected at metadata associated to the header “Data2” in the sequence of the frames 300C.

In an embodiment, each different text detected in a frame may be associated with a unique box-id. The sequencer block 104 may act as a multiple box error corrector in case there is a similar text associated with different box-ids.

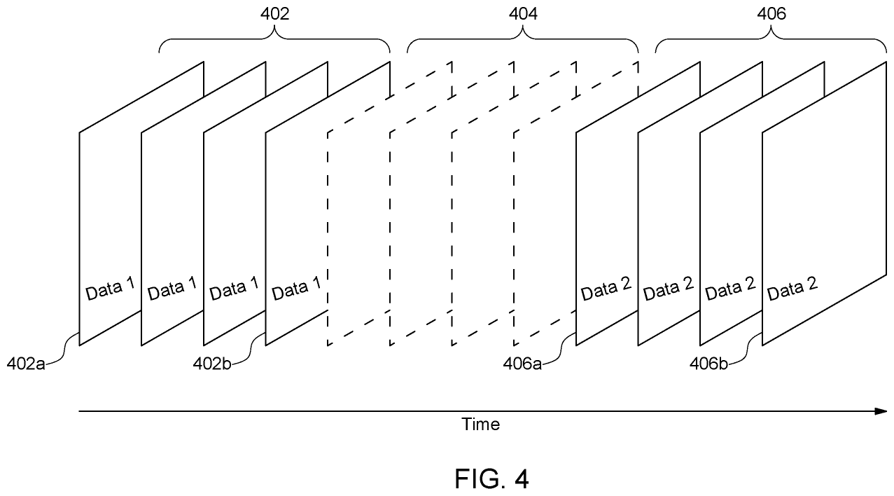

In an embodiment, output from the text sequencer block 104 may be sent as input to bucketer block 106. The bucketer block 106 may use one or more algorithms for creating a bucket of frames based on detection of similar text in a group of consecutive frames. In an embodiment, the text detection may be based on a pre-defined text quality criterion. The text quality criterion may include quality of presentation of text such as contrast of text data with respect to the background of the frame, clarity of text characters, spacing between the text characters. In an embodiment, the group of consecutive frames which may be detected to have similar text based on the text similarity criterion and may be bucketed together. FIG. 4 illustrates an exemplary embodiment depicting bucket creation of multiple frames present in the video, in accordance with an embodiment of the present disclosure. As shown in FIG. 4, a bucket of frames 402 is shown to include “Data1” in the group of consecutive frames. It can be seen that the text “Data1” is detected first in the in-frame 402a and can be seen to appear last in out-frame 402b of bucket 402. The detection in similarity of the text in the bucket 402 may be determined based on the text similarity criterion. One or more algorithm used may be, but not limited to, Natural Language Processing based machine learning algorithms for detection of similar text. In an embodiment, the text similarity may be determined based on presence of similar text characters up to a pre-define threshold level. Further, the position and sequence of the text characters may be determined based on which presence of similar text may be determined.

Further, it can be seen that bucket 404 includes a group of consecutive frames with no text. The subsequent bucket of frames 406 is detected to have a group of frames with text “Data2”. In an embodiment, a bucket of frames may also include similar text which is dynamic in nature and is tagged with the movement of text information. Accordingly, the text “Data2” is seen to first appear in an in-frame 406a of the bucket 406 and last seen in an out-frame 406b.

In an embodiment, each bucket may be defined as snippet of interrelated frames in a video comprising similar text. The bucket may also be associated with bucket information such as, but not limited to, frames per second, spacing between frames in a bucket.

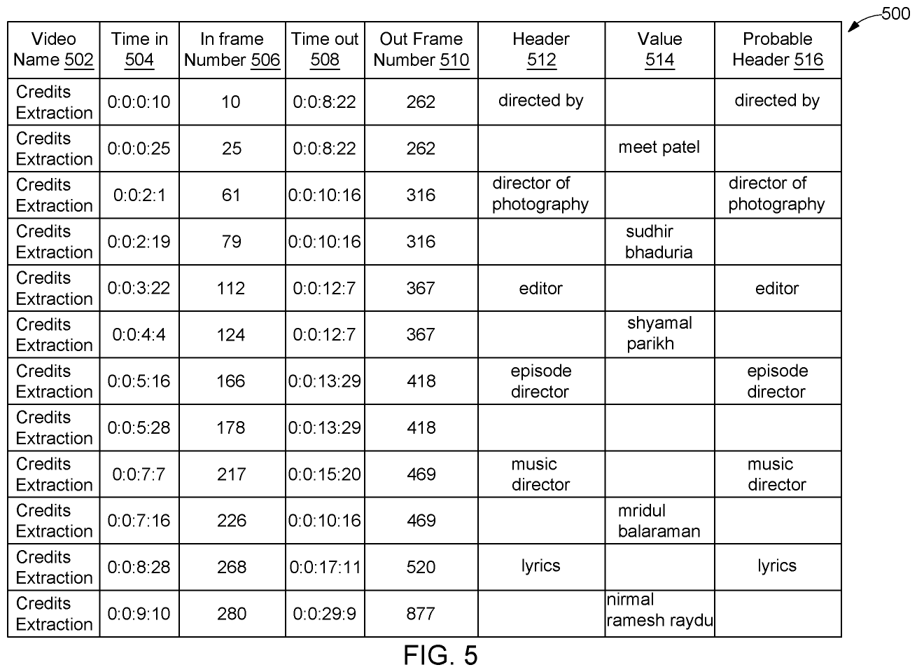

Referring to FIG. 1, the output from the bucketer block 106 may be received as input by a header-value detection block 108. The header-value detection block 108 is discussed in conjunction with respect to FIG. 5. FIG. 5 shows a table of exemplary text detected and metadata of a video for selective selection of text in a video, in accordance with an embodiment of the present disclosure.

The header-value detection block 108 may extract various types of text in each frame of the video, for example, subtitles information, sign-board text information, etc. To this end, the header-value detection block 108 may select a subset of header text characters. As shown in FIG. 5, table of exemplary text information derived from a video may be listed under column Header 512 or value 514. The column 514 may list the probable header detected by the text sequencer block 104. The header-value detection block 108 may populate a text map in the table 500 using the probable header 514 values and the grouping information, similarity information, etc. of the text detected in each frame. The header text characters may be mapped to the corresponding value text 514 in the text map. Subsequently, the header-value detection block 108 may create and save metadata results associated to each header and the value text in the table 500. The metadata of each value text 514 and the header 512 may include, but not limited to, input video file name 502, time-in 504, in-frame number 506, time-out 508, out-frame number 510, etc. It may be noted that the header-value detection block 108 may be use one or more algorithms suitable for metadata detection. It should be noted that the information presented in the Table 500 is merely an example implementation, and therefore the disclosure may not be considered limited to one such example implementation. In an embodiment, the time-in 504 information may depict the time of the video frame in which a header 512 or a value 514 is first detected. The in-frame number 506 may depict the frame number of the video in which a header 512 or a value 514 is first detected. The time-out 508 information may depict a time at which a header 512 or a value 514 is last seen in a video frame. The out-frame number 510 may depict a frame number in which a header 512 or a value 514 is last seen in a video. In an embodiment, the table 500 may also include a bucket number associated to each bucket corresponding to a header 512 or a value 514.

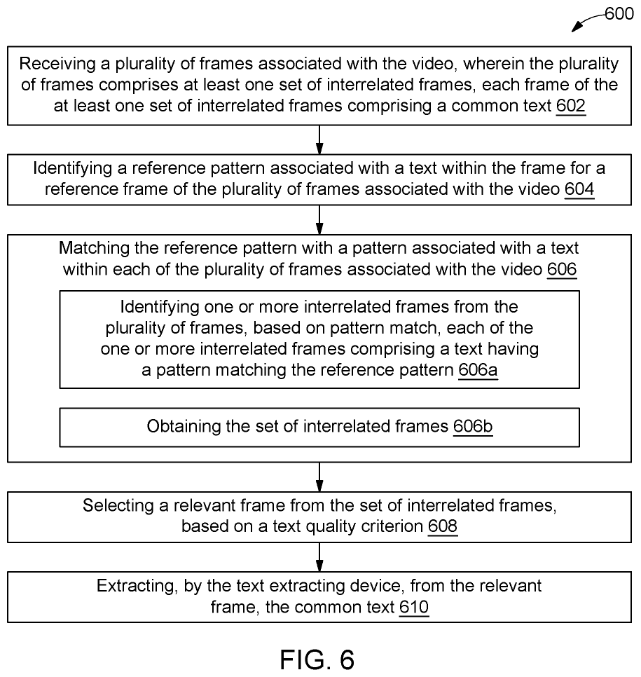

FIG. 6 illustrates a process flow 600 for extraction of text for performing selective searching of text in a video file, in accordance with an embodiment of the present disclosure. With reference to process flow 600, at step 602, a plurality of frames may be received by a text extracting device. The plurality of frames may include at least one set of interrelated frames which may comprise one or more common text. At step 604, a reference frame may be identified which may include a common text and a reference pattern may be identified associated to within the frame. At step 606, a reference pattern associated with a common text with the frame is identified for each reference frame. At step 606, the reference patter identified is matched with a pattern associated with a text within each of the plurality of frames. The step 606 further includes a sub-step 606a at which the reference pattern may be matched with a pattern associated with a common text by identifying one or more interrelated frames from the plurality of frames. The one or more interrelated frames may be identified based on a pattern match and may comprise a text having a pattern matching the reference pattern. At sub-step 606b the set of interrelated frames may be obtained. At step 608, a relevant frame from the set of interrelated frames may be selected based on a text quality criterion. At step 610, a common text may be extracted from the relevant frame.

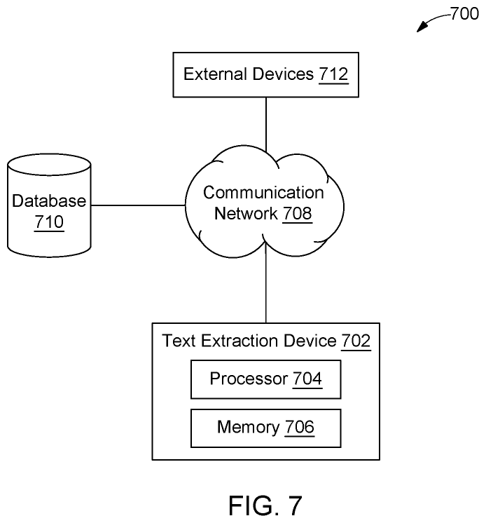

Referring now to FIG. 7, a block diagram of an environment 700 for extracting borderless structure from a document is illustrated, in accordance with an embodiment of the disclosure. As shown in the FIG. 7, the environment 700 may include a text extraction device 702, a database 710, an external device 712, and a communication network 708. The text extraction device 702 may be communicatively coupled to the database 710, and the external device 712, via the communication network 708.

The text extraction device 702 may include suitable logic, circuitry, interfaces, and/or code that may be configured to extract text from a video. The text extraction device 702 may include a processor 704 and a memory 706. The memory 706 may store one or more processor-executable instructions which on execution by the processor 704, may cause the processor 704 to perform one or more steps for extracting text from a video for selective searching of the text in the video. For example, the one or more steps may include receiving a plurality of frames of a video. The plurality of frames may comprise a time stamp of their occurrence in the video. In an embodiment, each frame of a video may be assigned a frame number based on a precedence of its occurrence in the video from starting to end. The one or more steps may further include detecting a text region indicative of a plurality of text characters in the plurality of frames. Further, upon detection of the text region, a position of the text region within the respective frames is determined. The one or more steps may then include identifying one or more interrelated frames based on the timestamp associated with each of the frames and the position of the text region within each of the plurality of frames. A relevant frame from the set of interrelated frames may be selected based on a text quality criterion and text may be extracted from the text region of the relevant frame. The one or more steps may also include populating in the cells of a tabular structure the extracted text, the relevant frame number, set of interrelated frames to which the relevant frame is associated to, etc.

The database 710 may include suitable logic, circuitry, interfaces, and/or code that may be configured to store data received, utilized, and processed by the text extraction device 702. Although in FIG. 7, the text extraction device 702 and the database 710 are shown as two separate entities, this disclosure is not so limited. Accordingly, in some embodiments, the entire functionality of the database 710 may be included in the text extraction device 702, without a deviation from scope of the disclosure. Additionally, the external device 712 may include suitable logic, circuitry, interfaces, and/or code that may be configured to communicate with a user. The functionalities of the external device 712 may be implemented in portable devices, such as a high-speed computing device, and/or non-portable devices, such as a server.

The communication network 708 may include a communication medium through which the text extraction device 702, the database 710, and the external device 712 may communicate with each other. Examples of the communication network 708 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the environment 700 may be configured to connect to the communication network 708, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity(Li-Fi), 802.16, IEEE 802.11s, IEEE 802.11g, multi-hop communication, wireless access point (AP), device to device communication, cellular communication protocols, and Bluetooth (BT) communication protocols.

It is intended that the disclosure and examples be considered as exemplary only, with a true scope and spirit of disclosed embodiments being indicated by the following claims.

1. A method for extracting text from a video, the method comprising:
receiving, by a text extracting device, a plurality of frames associated with the video, wherein the plurality of frames comprises at least one set of interrelated frames, each frame of the at least one set of interrelated frames comprising a common text;
for a reference frame of the plurality of frames associated with the video, identifying, by the text extracting device, a reference pattern associated with a text within the frame;
matching, by the text extracting device, the reference pattern with a pattern associated with a text within each of the plurality of frames associated with the video to:
identify one or more interrelated frames from the plurality of frames, based on pattern match, each of the one or more interrelated frames comprising a text having a pattern matching the reference pattern, and
obtain the set of interrelated frames;
selecting, by the text extracting device, a relevant frame from the set of interrelated frames, based on a text quality criterion; and
extracting, by the text extracting device, from the relevant frame, the common text.

2. The method as claimed in claim 1, wherein position of the common text within interrelated frames of the set of interrelated frames is one of static or moving.

3. The method as claimed in claim 1, further comprising:
arranging the one or more interrelated frames of the set of interrelated frames in a sequence, based on relative position of the common text within the interrelated frames of the set of interrelated frames, wherein the sequence is time-based.

4. The method as claimed in claim 1, further comprising:
upon extracting the common text, determining from the common text a header-text and a value-text associated with the header-text; and
populating a text map by mapping with the header-text the value-text associated with the header-text.

5. The method as claimed in claim 4, further comprising:
tagging a frame link with each of the header-text and the value-text associated with the header-text of the text map,
wherein the link is configured to direct playback of the video to the relevant frame.

6. A method for extracting text from a video, the method comprising:
receiving, by a text extracting device, a plurality of frames associated with the video, wherein reach of the plurality of frames comprises an associated time-stamp corresponding to the occurrence of the respective frame within the video;
detecting, by the text extracting device, within each of the plurality of frames, a text region indicative of a plurality of text characters,
upon detecting the text region, detecting, by the text extracting device, a position of the text region within the respective frame of the plurality of frames;
identifying, by the text extracting device, one or more interrelated frames, based on at least one of the time-stamp associated with each of the plurality of frames and the position of the text region within each of the plurality of frames, to create a set of interrelated frames;
selecting, by the text extracting device, a relevant frame from the set of interrelated frames, based on a text quality criterion; and
extracting, by the text extracting device, text from the text region of the relevant frame.

7. The method as claimed in claim 6, wherein identifying the one or more interrelated frames comprises performing at least one of:
determination of a repetition of the text region at same location in each of the set of interrelated frames; or
determination of pattern of relative change of the position of the text region within each frame of the set of interrelated frames.

8. A system for extracting text from a video, comprising:
one or more processors;
a memory communicatively coupled to the processor, wherein the memory stores a plurality of processor-executable instructions, which upon execution, cause the processor to:
receive a plurality of frames associated with the video, wherein the plurality of frames comprises at least one set of interrelated frames, each frame of the at least one set of interrelated frames comprising a common text;
for a reference frame of the plurality of frames associated with the video, identifying a reference pattern associated with a text within the frame;
matching the reference pattern with a pattern associated with a text within each of the plurality of frames associated with the video to:
identify one or more interrelated frames from the plurality of frames, based on pattern match, each of the one or more interrelated frames comprising a text having a pattern matching the reference pattern, and
obtain the set of interrelated frames;
selecting a relevant frame from the set of interrelated frames, based on a text quality criterion; and
extracting from the relevant frame, the common text.

9. A system for extracting text from a video, comprising:
one or more processors;
a memory communicatively coupled to the processor, wherein the memory stores a plurality of processor-executable instructions, which upon execution, cause the processor to perform the method as claimed in claim 6.

10. The system of claim 9, wherein the identification of the one or more interrelated frames comprises at least one of:
determination of a repetition of the text region at same location in each of the set of interrelated frames; or
determination of pattern of relative change of the position of the text region within each frame of the set of interrelated frames.
